(19) United States
(12) Patent Application Publication
(10) Pub. No.: US 2017/0166143 A1
(43) Pub. Date: Jun. 15, 2017

(54) METHOD FOR IMPLEMENTING AUTOMOBILE CONTROL SYSTEM AND ELECTRONIC DEVICE

(71) Applicants: Le Holdings (Beijing) Co., Ltd., Beijing (CN); Lemobile Information Technology (Beijing) Co., Ltd, Beijing (CN)

(72) Inventor: Lei DENG, Beijing (CN)

(21) Appl. No.: 15/246,533

(22) Filed: Aug. 25, 2016

Related U.S. Application Data
(63) Continuation of application No. PCT/CN2016/089473, filed on Jul. 8, 2016.

(30) Foreign Application Priority Data
Dec. 11, 2015 (CN) 201510921230.6

(51) Int. Cl. B60R 16/023; H04M 1/02; H04M 1/04; H02J 7/00

(52) U.S. Cl. CPC B60R 16/023; H02J 7/0052; H04M 1/0274; H04M 1/04; H04W 88/02

(57) ABSTRACT

Disclosed are a method for implementing an automobile control system and an electronic device. The method includes: determining whether a mobile phone is inserted into a slot at a preset position of an automobile; connecting the mobile phone to the automobile control system when a determination result is yes; and providing a task processing capacity for the automobile control system by utilizing a mobile phone system.

### CROSS REFERENCE TO RELATED APPLICATIONS

This application is a continuation of International Application No. PCT/CN2016/089473, filed on Jul. 8, 2016, which is based upon and claims priority to Chinese Patent Application No. 201510921230.6, filed on Dec. 11, 2015, the entire contents of all of which are incorporated herein by reference.

### TECHNICAL FIELD

The present disclosure relates to smart hardware, and more particularly, to a method for implementing an automobile control system and an electronic device.

### BACKGROUND

With the development of automobile industries and improvement of people's living standards, automobiles have been widely used in a growing number of families. Automobiles have become third space for people in addition to homes and workplaces. Meanwhile, smart mobile phones also have become indispensable tools in people's lives.

At present, in a process of using an automobile, an automobile cigar lighter is used as a power socket to directly charge a mobile phone by means of an on-board charger. However, for the most part, control of the automobile is implemented by means of various vehicle controllers such as a central control door lock system, a central control console and an audio control panel or the like of the automobile. As a commonly-used smart terminal, a mobile phone has less interaction with an automobile in other aspects excluding charging the mobile phone in the automobile, and the automobile and the mobile phone are separately used. Therefore, it becomes a problem to be solved urgently in the prior art how to implement a central control function of an automobile by utilizing a mobile phone in a process of using the automobile.

### SUMMARY

The present disclosure provides a method for implementing an automobile control system and an electronic device to solve a defect of the prior art in which interaction of functions of an automobile and a mobile phone is unachievable because they are separately used.

In a first aspect, embodiments of the present disclosure provide a method for implementing an automobile control system, implemented by a terminal, including:

determining whether a mobile phone is inserted into a slot at a preset position of an automobile;

connecting the mobile phone to the automobile control system when a determination result is yes; and

providing a task processing capacity for the automobile control system by utilizing a mobile phone system.

In a second aspect, embodiments of the present disclosure provide a non-transitory computer-readable storage medium storing executable instructions, wherein the executable instructions are configured to perform any methods for implementing an automobile control system mentioned by embodiments of the present disclosure.

In a third aspect, embodiments of the present disclosure provide an electronic device, including: at least one processor; and a memory communicably connected with the at least one processor for storing instructions executable by the at least one processor, wherein execution of the instructions by the at least one processor causes the at least one processor to perform any methods for implementing an automobile control system mentioned by embodiments of the present disclosure.

The method for implementing an automobile control system and the electronic device provided by the embodiments of the present disclosure can determine whether a mobile phone is inserted into a slot at a preset position of an automobile, connect the mobile phone to the automobile control system when a determination result is yes, and provide a task processing capacity for the automobile control system by utilizing a mobile phone system. Compared with the prior art in which when a mobile phone is used in an automobile, for the most part merely a cigar lighter on the automobile is used as a power socket to directly charge the mobile phone and thus it has an defect that the automobile and the mobile phone are separately used, in the embodiments of the present disclosure, by means of coordinate application of a mobile phone and a slot built in a front desk of an automobile, interaction of functions of the automobile and the mobile phone is implemented, and the mobile phone can provide a smart control system for the automobile.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart of a method for implementing an automobile control system in accordance with some embodiments;

FIG. 2 is a block diagram showing constitution of an apparatus for implementing an automobile control system in accordance with some embodiments;

FIG. 3 is a block diagram showing constitution of another apparatus for implementing an automobile control system in accordance with some embodiments;

FIG. 4 is a schematic structural diagram of a server in accordance with some embodiments; and

FIG. 5 is a block diagram of an electronic device which is configured to perform the methods for implementing an automobile control system in accordance with some embodiments.

### DETAILED DESCRIPTION

To make the objectives, technical solutions, and advantages of the embodiments of the present disclosure clearer, the following clearly and completely describes the technical solutions in the embodiments of the present disclosure with combination of the accompanying drawings in the embodiments of the present disclosure. Apparently, the described embodiments are some but not all of the embodiments of the present disclosure.

As tools commonly used in people's everyday life, an automobile and a mobile phone have less interaction in other aspects excluding charging the mobile phone in the automobile, and thus the automobile and the mobile phone are separately used.

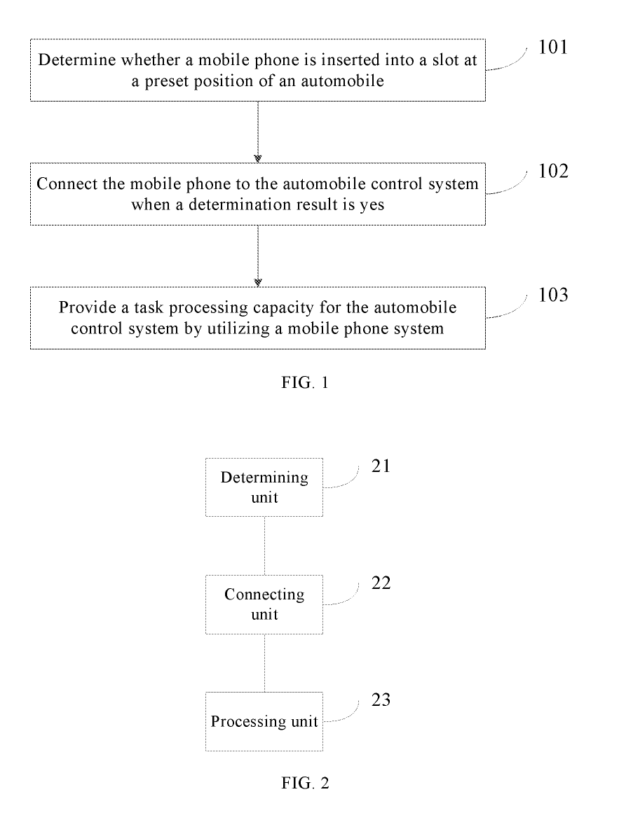

In order to solve the defect in the prior art that interaction of functions of an automobile and a mobile phone cannot be implemented because they are separately used, embodiments of the present disclosure provide a method for implementing an automobile control system to implement an objective of a central control function of an automobile by utilizing a mobile phone in a process of using the automobile. As shown in FIG. 1, the method includes:

101: it is determined whether a mobile phone is inserted into a slot at a preset position of an automobile.

In the prior art, when a mobile phone is used in an automobile, generally an automobile cigar lighter is used as a power socket to directly charge the mobile phone by means of an on-board charger, and neither data interaction nor system connection is available between the mobile phone and the automobile. However, in the embodiments of the present disclosure, a slot specially used for inserting a mobile phone is built in a preset position of an automobile, and data interaction and system connection can be implemented between the automobile and the mobile phone by inserting the mobile phone into the slot. Therefore, when the method provided by the embodiments of the present disclosure is utilized to implement the automobile control system, Step 101 needs to be executed to determine whether a mobile phone is inserted into the slot at the preset position of the automobile.

102: the mobile phone is connected to the automobile control system when a determination result is yes.

After it is determined that the mobile phone is inserted into the slot at the preset position of the automobile, in the embodiments of the present disclosure, the mobile phone needs to be connected to the automobile control system through an interface disposed in the slot for interacting with the mobile phone. The interface disposed in the slot has a function of direct data interaction and system connection.

103: a task processing capacity is provided for the automobile control system by utilizing a mobile phone system.

After the mobile phone is connected to the automobile control system in Step 102, since a connection relation has been established between the mobile phone system and the automobile control system and a data interaction capability is provided, the task processing capacity can be provided for the automobile control system by utilizing the mobile phone system, and the automobile can be controlled by utilizing a system operation capability of the mobile phone.

The method for implementing an automobile control system provided by the embodiments of the present disclosure can determine whether a mobile phone is inserted into a slot at a preset position of an automobile, connect the mobile phone to the automobile control system when a determination result is yes, and provide a task processing capacity for the automobile control system by utilizing a mobile phone system. Compared with the prior art in which when a mobile phone is used in an automobile, for the most part merely a cigar lighter on the automobile is used as a power socket to directly charge the mobile phone and thus it has an defect that the automobile and the mobile phone are separately used, in the embodiments of the present disclosure, by means of coordinate application of a mobile phone and a slot built in a front desk of an automobile, interaction of functions of the automobile and the mobile phone is implemented, and the mobile phone can provide a smart control system for the automobile.

In order to better understand the method as shown in FIG. 1, as refinement and expansion of the foregoing implementation, detailed description of each step in FIG. 1 will be made in the embodiments of the present disclosure.

In the embodiments of the present disclosure, to ensure the mobile phone inserted into the slot to be used relatively conveniently, the slot built in the automobile generally is positioned in different positions of the front desk of the automobile, for example, the slot can be built in a central control console on the front desk of the automobile or built in a glovebox on the front desk of the automobile. Therefore, when it is determined whether a mobile phone is inserted into the slot at the preset position of the automobile, it can be determined whether the mobile phone is inserted into the slot on the central control console preinstalled on the front desk of the automobile; or it is determined whether the mobile phone is inserted into the slot at the glovebox preinstalled on the front desk of the automobile.

After a mobile phone is inserted into the slot, it cannot be ensured that the mobile phone has a connection relation with the automobile control system, and insertion of the mobile phone into the slot can be divided into following two cases: 1) the mobile phone is positioned in the slot but is not connected with the automobile control system; 2) the mobile phone is positioned in the slot and is connected with the automobile control system. If a mobile phone is not normally connected with a communication interface disposed in the slot, the data interaction and connection are unavailable between the mobile phone and the automobile control system. Therefore, in the embodiments of the present disclosure, when it is determined whether a mobile phone is inserted into the slot at the preset position of the automobile, it is required to determine whether the mobile phone is inserted into the slot by determining whether the mobile phone is connected to the communication interface in the slot at the preset position. In the embodiments of the present disclosure, the communication interface disposed in the slot is an interface for communication and data interaction between a central processing unit of the automobile control system and the mobile phone system. The communication interface can be disposed as a serial communication interface or a parallel communication interface according to a performance (CPU) of a connected mobile phone. In the embodiments of the present disclosure, since a communication interface for connecting with a mobile phone is disposed in the slot built in the automobile, the mobile phone can be connected with the automobile control system as long as the mobile phone is normally connected with the communication interface in the slot, thereby ensuring a normal connection between the mobile phone and the automobile control system in case of no network. Of course, in the embodiments of the present disclosure, a wireless LAN card can also be disposed in the automobile control system so that a mobile phone can be conveniently connected with the automobile control system via the Internet.

Generally, after a mobile phone is inserted into a slot built in the automobile and is connected with the communication interface in the slot, the mobile phone system can be connected with the automobile control system for data interaction, and now control of the automobile can be implemented by means of the mobile phone. Generally, since one mobile phone is limited in performance, namely its operation processing capacity is limited, the embodiments of the present disclosure provide an alternative implementation, namely control of the automobile can be implemented by means of operation processing capacities of multiple mobile phones. In order to achieve the above-mentioned objective, in the embodiments of the present disclosure, multiple slots (at least two) can be built in the preset position of the automobile, and the multiple slots constitute a slot group to work by taking the slot group as a unit. Between slots in the slot group there is provided with a communication interface, through which integrated connection of mobile phones inserted into the slots can be implemented. After multiple mobile phones are inserted into the slot group, system operation capabilities of the mobile phones can be integrated through the communication interface between slots to control the automobile.

In the embodiments of the present disclosure, a communication interface is disposed in a slot to connect a mobile phone with the automobile control system, and a communication interface is disposed between slots to implement an integrated connection of multiple mobile phones. Further, in the embodiments of the present disclosure, a metal sheet is disposed in the slot, a mobile phone is charged by contacting the metal sheet with a contact piece at a corresponding position of the mobile phone. The metal sheet can be positioned at a bottom of the slot or positioned at an inner side of the slot. After the mobile phone is completely inserted into the slot, the metal sheet in the slot can contact with the contact piece at the corresponding position of the mobile phone, so that the mobile phone is charged by utilizing a generator or an accumulator battery of the automobile. When a slot group composed of multiple slots is built in the automobile, multiple mobile phones can be charged by means of slots in the slot group.

It is to be noted that in allusion to the foregoing implementation, the mobile phone system inserted into the slot at the preset position of the automobile shall be the same as the automobile control system, or the mobile phone system can normally interact with the automobile control system through system transformation. Reference is made to the method for implementing an automobile control system in the following by taking an example in which a dedicated slot group composed of five slots is built in the central control console of the automobile.

First of all, after five mobile phones are respectively inserted into slots in the slot group, it is required to determine whether each mobile phone is inserted to each slot by determining whether each mobile phone is normally connected to a communication interface of each slot. After it is determined a mobile phone is successfully inserted into the slot (in this embodiment supposing all the five mobile phones are successfully inserted into the slots), the mobile phone can be connected to the automobile control system by means of the communication interface in the slot. Further, since communication interfaces are provided among five slots in the slot group, integrated connection of the five inserted mobile phones can be implemented through the communication interfaces among the slots in the slot group. The five mobile phones have been mutually connected to form a mobile phone cluster, and each mobile phone is connected with the automobile control system. Therefore, a compound-type task processing capacity can be provided for the automobile control system by means of a system operation capability of each mobile phone in the mobile phone cluster, where the compound-type task includes at least two tasks. For example, the five mobile phones can respectively take charge of processing a central control door lock system, an audio control panel, an air-conditioner control system, an automobile starting system and a seat adjusting system of the automobile. After a mobile phone is inserted into the slot through the above mentioned way, the mobile phone system can be connected to the automobile control system and used as a smart control system of the automobile. When multiple mobile phones are inserted into the slot group built in the automobile, not only the mobile phones can be used as smart keys for starting the automobile, but also built-in sound equipment, an air conditioner, door locks, seats and windows or the like of the automobile can be adjusted through the mobile phones. Furthermore, a metal sheet built in at the bottom or the inner side of the slot can contact with a contact piece at a corresponding position of a mobile phone, so that the mobile phone is charged by means of a generator or an accumulator battery of the automobile. When multiple mobile phones are inserted into the slot group, the multiple mobile phones can be simultaneously charged.

In the embodiments of the present disclosure, a communication interface is disposed in a slot so that a mobile phone system is connected with the automobile control system. Besides, a metal sheet for charging a mobile phone is also disposed in the slot, so that the mobile phone system not only can be used as a smart control system of the automobile, but also can charge a mobile phone. When there are multiple slots, communication interfaces can be disposed among the multiple slots to form a slot group, which not only can integrate multiple mobile phones by means of the slot group so that a compound-type task processing capacity is provided for the automobile control system by utilizing system operation capabilities of the multiple mobile phones, but also the multiple mobile phones can be simultaneously charged, thereby achieving interaction of more functions of the mobile phones and the automobile, and providing more diverse and more convenient implementations for the automobile control system.

As an application of the method as shown in FIG. 1, embodiments of the present disclosure provide an apparatus for implementing an automobile control system, as shown in FIG. 2, the apparatus includes: a determining unit 21, a connecting unit 22, and a processing unit 23, where

the determining unit 21 is configured to determine whether a mobile phone is inserted into a slot at a preset position of an automobile;

the connecting unit 22 is configured to connect the mobile phone to the automobile control system when a determination result of the determining unit 21 is yes; and

the processing unit 23 is configured to provide a task processing capacity for the automobile control system by utilizing a mobile phone system.

Further, the determining unit 21 is configured to determine whether a mobile phone is inserted into a slot on a central control console preinstalled on a front desk of the automobile; and the determining unit 21 is further configured to determine whether a mobile phone is inserted into a slot at a glovebox preinstalled on the front desk of the automobile.

Further, the determining unit 21 is configured to determine whether a mobile phone is connected to a communication interface in the slot at the preset position of the automobile.

Further, the determining unit 21 is configured to determine whether a mobile phone is inserted into each slot in the slot group at the preset position of the automobile, where the slot group has at least two slots and a communication interface is provided between slots in the slot group.

Further, the connecting unit 22 is configured to connect the mobile phone to the automobile control system through the communication interface in the slot.

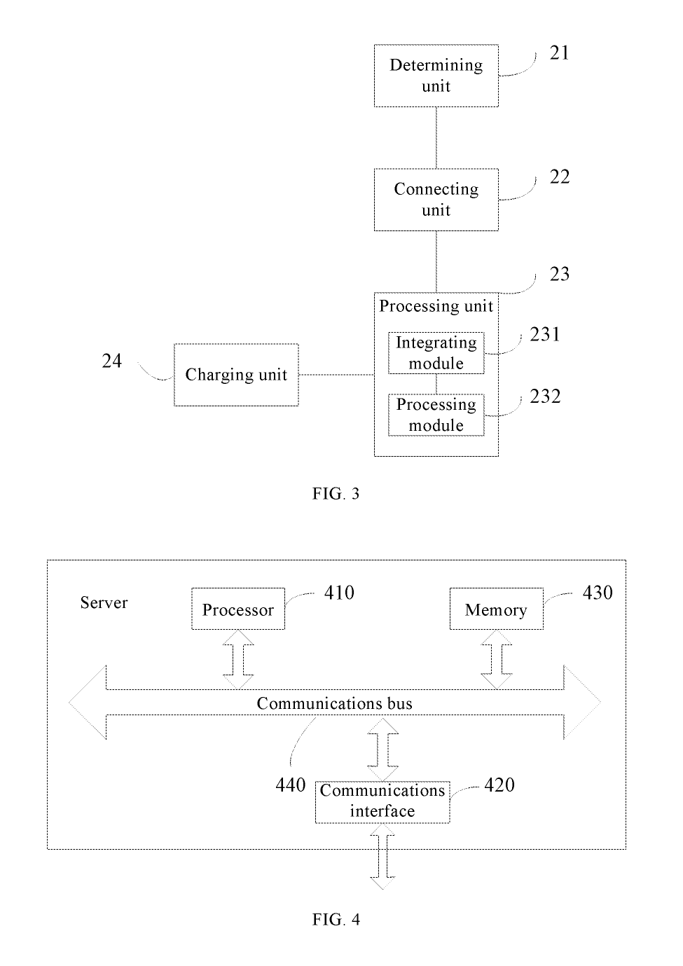

Further, as shown in FIG. 3, the apparatus further includes:

a charging unit 24, configured to charge the mobile phone, specifically

the charging unit 24 is configured to charge the mobile phone by means of a metal sheet at a bottom of the slot; and

the charging unit 24 is further configured to charge the mobile phone by means of a metal sheet at an inner side of the slot.

Further, the processing unit 23 is configured to start the automobile by utilizing a system operation capability of the mobile phone.

Further, as shown in FIG. 3, the processing unit 23 includes:

an integrating module 231, configured to integrate inserted mobile phones by utilizing communication interfaces between slots in the slot group; and

a processing module 232, configured to provide a compound-type task processing capacity for the automobile control system by utilizing system operation capabilities of the integrated mobile phones, where the compound-type task includes at least two tasks.

The apparatus for implementing an automobile control system provided by the embodiments of the present disclosure can determine whether a mobile phone is inserted into a slot at a preset position of an automobile, connect the mobile phone to the automobile control system when a determination result is yes, and provide a task processing capacity for the automobile control system by utilizing a mobile phone system. Compared with the prior art in which when a mobile phone is used in an automobile, for the most part merely a cigar lighter on the automobile is used as a power socket to directly charge the mobile phone and thus it has an defect that the automobile and the mobile phone are separately used, in the embodiments of the present disclosure, by means of coordinate application of a mobile phone and a slot built in a front desk of an automobile, interaction of functions of the automobile and the mobile phone is implemented, and the mobile phone can provide a smart control system for the automobile.

Furthermore, in the apparatus for implementing an automobile control system provided by the embodiments of the present disclosure, a communication interface is disposed in a slot so that a mobile phone system is connected with the automobile control system. Besides, a metal sheet for charging a mobile phone is also disposed in the slot, so that the mobile phone system not only can be used as a smart control system of the automobile, but also can charge a mobile phone. When there are multiple slots, communication interfaces can be disposed among the multiple slots to form a slot group, which not only can integrate multiple mobile phones by means of the slot group so that a compound-type task processing capacity is provided for the automobile control system by utilizing system operation capabilities of the multiple mobile phones, but also the multiple mobile phones can be simultaneously charged, thereby achieving interaction of more functions of the mobile phones and the automobile, and providing more diverse and more convenient implementations for the automobile control system.

In allusion to the foregoing apparatus for implementing an automobile control system, it is to be noted that functions of each unit module used in the embodiments of the present disclosure can be implemented through a hardware processor.

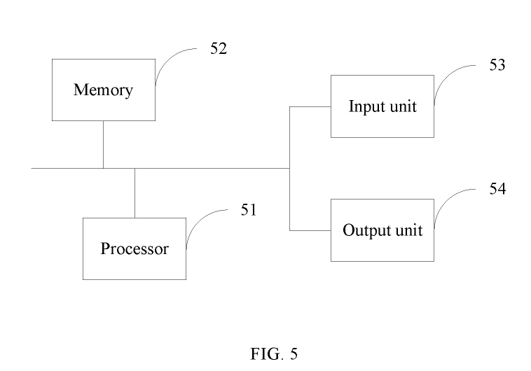

FIG. 4 illustrates a schematic structural diagram of a server, as shown in FIG. 4, the server can include: a processor 410, a communications interface 420, a memory 430 and a communications bus 440, where the processor 410, the communications interface 420 and the memory 430 complete communications among each other through the communications bus 440. The communications interface 420 can be configured to implement information transmission between the server and the client. The processor 410 can invoke a logic instruction in the memory 430 to execute the following method: sending a request of a client to a transition server based on a preset IP address; forwarding, by the transition server, the request of the client to an execution server; searching for a corresponding domain name resolution result from the execution server according to the request; and returning the corresponding domain name resolution result to the client.

In addition, when a logic instruction in the foregoing memory 430 can be implemented in the form of a software functional unit and is sold or used as an independent product, the logic instruction can be stored in a computer-readable storage medium. Based on such understanding, the essence of or a part of the technical solutions in the present disclosure (that is, the part making contributions over prior arts) may be embodied as software products. The computer software products may be stored in a storage medium including instructions which enable a computer device (for example, a personal computer, a server or a network device, and so on) to perform whole or a part of the steps in the methods according to various embodiments of the present disclosure. The above mentioned storage medium may include various mediums capable of storing program codes, for example, a USB flash drive, a mobile hard disk drive, a read only memory (ROM), a random access memory (RAM), a magnetic disk or an optical disk, and so on.

Further, an embodiment of the present disclosure further provides a non-transitory computer-readable storage medium storing executable instructions, which can be executed by an electronic device to perform any methods for implementing an automobile control system mentioned by embodiments of the present disclosure.

FIG. 5 is a block diagram of an electronic device which is configured to perform the methods for implementing an automobile control system according to an embodiment of the present disclosure. As shown in FIG. 5, the device includes:

one or more processors 51 and memory 52. A processor 51 is showed in FIG. 5 for an example.

Device which is configured to perform the methods for implementing an automobile control system can also include: input unit 53 and output unit 54.

Processor 51, memory 52, input unit 53 and output unit 54 can be connected by BUS or other methods, and BUS connecting is showed in FIG. 5 for an example.

Memory 52 can be used for storing non-transitory software program, non-transitory computer executable program and modules as a non-transitory computer-readable storage medium, such as corresponding program instructions/modules for the methods for implementing an automobile control system mentioned by embodiments of the present disclosure (such as shown in FIG. 2, determining unit 21, connecting unit 22 and processing unit 23). Processor 51 performs kinds of functions and implementing an automobile control system of the electronic device by executing non-transitory software program, instructions and modules which are stored in memory 52, thereby realizes the methods for implementing an automobile control system mentioned by embodiments of the present disclosure.

Memory 52 can include program storage area and data storage area, thereby the operating system and applications required by at least one function can be stored in program storage area and data created by using the device for implementing an automobile control system can be stored in data storage area. Furthermore, memory 52 can include high speed Random-access memory (RAM) or non-volatile memory such as magnetic disk storage device, flash memory device or other non-volatile solid state storage devices. In some embodiments, memory 52 can include long-distance setup memories relative to processor 51, which can communicate with the device for implementing an automobile control system by networks. The examples of said networks are including but not limited to Internet, Intranet, LAN, mobile Internet and their combinations.

Input unit 53 can be used to receive inputted number, character information and key signals causing user configures and function controls of the device for implementing an automobile control system. Output unit 54 can include a display screen or a display device.

The said module or modules are stored in memory 52 and perform the methods for implementing an automobile control system when executed by one or more processors 51.

The said device can reach the corresponding advantages by including the function modules or performing the methods provided by embodiments of the present disclosure. Those methods can be referenced for technical details which may not be completely described in this embodiment.

Electronic devices in embodiments of the present disclosure can be existences with different types, which are including but not limited to:

(1) Mobile Internet devices: devices with mobile communication functions and providing voice or data communication services, which include smartphones (e.g. iPhone), multimedia phones, feature phones and low-cost phones.

(2) Super mobile personal computing devices: devices belong to category of personal computers but mobile internet function is provided, which include PAD, MID and UMPC devices, e.g. iPad.

(3) Portable recreational devices: devices with multimedia displaying or playing functions, which include audio or video players, handheld game players, e-book readers, intelligent toys and vehicle navigation devices.

(4) Servers: devices with computing functions, which are constructed by processors, hard disks, memories, system BUS, etc. For providing services with high reliabilities, servers always have higher requirements in processing ability, stability, reliability, security, expandability, manageability, etc., although they have a similar architecture with common computers.

(5) Other electronic devices with data interacting functions.

The embodiments of devices are described above only for illustrative purposes. Units described as separated portions may be or may not be physically separated, and the portions shown as respective units may be or may not be physical units, i.e., the portions may be located at one place, or may be distributed over a plurality of network units. A part or whole of the modules may be selected to realize the objectives of the embodiments of the present disclosure according to actual requirements.

In view of the above descriptions of embodiments, those skilled in this art can well understand that the embodiments can be realized by software plus necessary hardware platform, or may be realized by hardware. Based on such understanding, it can be seen that the essence of the technical solutions in the present disclosure (that is, the part making contributions over prior arts) may be embodied as software products. The computer software products may be stored in a computer readable storage medium including instructions, such as ROM/RAM, a magnetic disk, an optical disk, to enable a computer device (for example, a personal computer, a server or a network device, and so on) to perform the methods of all or a part of the embodiments.

It shall be noted that the above embodiments are disclosed to explain technical solutions of the present disclosure, but not for limiting purposes. While the present disclosure has been described in detail with reference to the above embodiments, those skilled in this art shall understand that the technical solutions in the above embodiments can be modified, or a part of technical features can be equivalently substituted, and such modifications or substitutions will not make the essence of the technical solutions depart from the spirit or scope of the technical solutions of various embodiments in the present disclosure.

What is claimed is:

1. A method for implementing an automobile control system, implemented by a terminal, comprising:
determining whether a mobile phone is inserted into a slot at a preset position of an automobile;
connecting the mobile phone to the automobile control system when a determination result is yes; and
providing a task processing capacity for the automobile control system by utilizing a mobile phone system.

2. The method according to claim 1, wherein the determining whether a mobile phone is inserted into a slot at a preset position of an automobile comprises:
determining whether a mobile phone is inserted into a slot on a central control console preinstalled on a front desk of the automobile; or
determining whether a mobile phone is inserted into a slot at a glovebox preinstalled on the front desk of the automobile.

3. The method according to claim 1, wherein the determining whether a mobile phone is inserted into a slot at a preset position of an automobile comprises:
determining whether a mobile phone is connected to a communication interface in the slot at the preset position.

4. The method according to claim 1, wherein the slot at the preset position comprises:
a slot group, wherein the slot group has at least two slots and a communication interface is provided between slots in the slot group; and
the determining whether a mobile phone is inserted into a slot at a preset position of an automobile comprises:
determining whether a mobile phone is inserted into each slot in the slot group at the preset position of the automobile.

5. The method according to claim 3, wherein the connecting the mobile phone to the automobile control system comprises:
connecting the mobile phone to the automobile control system through the communication interface in the slot.

6. The method according to claim 1, wherein after the determination result is yes, the method further comprises:
charging the mobile phone; wherein the charging the mobile phone comprises:
charging the mobile phone by means of a metal sheet at a bottom of the slot; or charging the mobile phone by means of a metal sheet at an inner side of the slot.

7. The method according to claim 1, wherein the providing a task processing capacity for the automobile control system by utilizing a mobile phone system comprises:
starting the automobile by utilizing a system operation capability of the mobile phone.

8. The method according to claim 4, wherein the providing a task processing capacity for the automobile control system by utilizing a mobile phone system comprises:
integrating inserted mobile phones by utilizing communication interfaces between slots in the slot group; and
providing a compound-type task processing capacity for the automobile control system by utilizing system operation capabilities of the integrated mobile phones, wherein the compound-type task comprises at least two tasks.

9. An electronic device, comprising:
at least one processor; and
a memory communicably connected with the at least one processor for storing instructions executable by the at least one processor, wherein execution of the instructions by the at least one processor causes the at least one processor to:
determine whether a mobile phone is inserted into a slot at a preset position of an automobile;
connect the mobile phone to the automobile control system when a determination result is yes; and
provide a task processing capacity for the automobile control system by utilizing a mobile phone system.

10. The electronic device according to claim 9, wherein the determining whether a mobile phone is inserted into a slot at a preset position of an automobile comprises:
determining whether a mobile phone is inserted into a slot on a central control console preinstalled on a front desk of the automobile; or
determining whether a mobile phone is inserted into a slot at a glovebox preinstalled on the front desk of the automobile.

11. The electronic device according to claim 9, wherein the determining whether a mobile phone is inserted into a slot at a preset position of an automobile comprises:
determining whether a mobile phone is connected to a communication interface in the slot at the preset position.

12. The electronic device according to claim 9, wherein the slot at the preset position comprises:
a slot group, wherein the slot group has at least two slots and a communication interface is provided between slots in the slot group;
the determining whether a mobile phone is inserted into a slot at a preset position of an automobile comprises:
determining whether a mobile phone is inserted into each slot in the slot group at the preset position of the automobile.

13. The electronic device according to claim 11, wherein the connecting the mobile phone to the automobile control system comprises:
connecting the mobile phone to the automobile control system through the communication interface in the slot.

14. The electronic device according to claim 9, wherein after the determination result is yes, the instructions are executed to cause the at least one processor to:
charge the mobile phone; wherein the charging the mobile phone comprises:
charging the mobile phone by means of a metal sheet at a bottom of the slot; or charging the mobile phone by means of a metal sheet at an inner side of the slot.

15. The electronic device according to claim 9, wherein the providing a task processing capacity for the automobile control system by utilizing a mobile phone system comprises:
starting the automobile by utilizing a system operation capability of the mobile phone.

16. The electronic device according to claim 12, wherein the providing a task processing capacity for the automobile control system by utilizing a mobile phone system comprises:
integrating inserted mobile phones by utilizing communication interfaces between slots in the slot group; and
providing a compound-type task processing capacity for the automobile control system by utilizing system operation capabilities of the integrated mobile phones, wherein the compound-type task comprises at least two tasks.

17. A non-transitory computer-readable storage medium storing executable instructions, wherein the executable instructions are configured to:
determine whether a mobile phone is inserted into a slot at a preset position of an automobile;
connect the mobile phone to the automobile control system when a determination result is yes; and
provide a task processing capacity for the automobile control system by utilizing a mobile phone system.

18. The non-transitory computer-readable storage medium according to claim 17, wherein the determining whether a mobile phone is inserted into a slot at a preset position of an automobile comprises:
determining whether a mobile phone is inserted into a slot on a central control console preinstalled on a front desk of the automobile; or
determining whether a mobile phone is inserted into a slot at a glovebox preinstalled on the front desk of the automobile.

19. The non-transitory computer-readable storage medium according to claim 17, wherein the determining whether a mobile phone is inserted into a slot at a preset position of an automobile comprises:
determining whether a mobile phone is connected to a communication interface in the slot at the preset position.

20. The non-transitory computer-readable storage medium according to claim 17, wherein the slot at the preset position comprises:
a slot group, wherein the slot group has at least two slots and a communication interface is provided between slots in the slot group;
the determining whether a mobile phone is inserted into a slot at a preset position of an automobile comprises:
determining whether a mobile phone is inserted into each slot in the slot group at the preset position of the automobile.
